(19) United States
(12) Patent Application Publication
(10) Pub. No.: US 2025/0290488 A1
(43) Pub. Date: Sep. 18, 2025

(54) HYBRID VENTING APPARATUS FOR GENERATING ELECTRICITY, SYSTEM AND METHOD

(71) Applicant: REBUS CORPORATION PTY LTD, Prahran, Victoria (AU)

(72) Inventor: Peter BLOOMFIELD, Prahran (AU)

(73) Assignee: REBUS CORPORATION PTY LTD, Prahran, Victoria (AU)

(21) Appl. No.: 18/862,900

(22) PCT Filed: May 2, 2023
(86) PCT No.: PCT/AU2023/050364

§ 371 Date: Nov. 4, 2024

(30) Foreign Application Priority Data
May 5, 2022 (AU) 2022901191

(51) Int. Cl. F03D 9/37; F03D 9/00; F03D 9/11; H02S 10/12; H02S 20/26; H02S 40/22; H02S 40/44

(52) U.S. Cl. CPC F03D 9/37; F03D 9/007; F03D 9/11; H02S 10/12; H02S 20/26; H02S 40/22; H02S 40/44; F05B 2220/64; F05B 2220/7068; F05B 2220/708; F05B 2240/9112; F05B 2250/232; F05B 2260/24

(57) ABSTRACT

A venting apparatus for generating electricity, the apparatus comprising a head and a base, whereby rotation of the head relative to the base generates electricity, wherein the head includes: a receptacle in which is disposed a solar cell, and a plurality of blades disposed around a periphery of the head for rotating the head in response to airflow around and/or over the head.

### FIELD OF THE INVENTION

The present invention relates to a hybrid venting apparatus for generating electricity, a system and method.

### BACKGROUND

The world is transitioning towards green energy solutions in view of the rapidly developing climate crisis.

However, commonly available green power generation systems are not sufficient to meet consumers demands. In this regard, the Applicant has determined that the highest point of energy consumption within communities is during the middle of winter or the coldest months, together with the midpoint of summer months or hottest part of the year. The Applicant has also determined that although consumer consumption peaks at these points, the potential for green energy production via currently available green power generation systems are inefficient at these respective points in the calendar with the sun not shining or little wind being available.

It is therefore desirable to supplement present commercial scale energy generation with additional green energy generation systems. It is also desirable to harvest energy close to the intended point of use.

There is a need to address the above, and/or at least provide a useful alternative.

### SUMMARY

According to one aspect of the invention there is provided a venting apparatus for generating electricity, the apparatus comprising a head and a base, whereby rotation of the head relative to the base generates electricity, wherein the head includes:
a receptacle in which is disposed a solar cell, and
a plurality of blades disposed around a periphery of the head for rotating the head in response to airflow around and/or over the head.

According to preferred embodiments of the invention, the receptacle is a generally conical structure. Preferably, the blades are disposed around a periphery of the conical structure.

The apparatus can further comprise a convex lens or combination of convex lens with Fresnel lens apparatus disposed in an upper of the receptacle for focusing and concentrating sunlight onto the solar cell and configured to extend this concentration of sunlight for maximum solar exposure.

Preferably, the solar cell is a CPV solar cell and configured to output electricity and heat. The receptacle can have a plurality of circumferentially spaced openings formed in an upper portion thereof and through which thermal heat can escape. Preferably, the openings are positioned so that air exiting the openings is directed to the blades to cause rotation of the head.

According to preferred embodiments, the apparatus can further comprise at least one energy conversion device for converting rotational energy of the head into electrical energy. Preferably, the energy conversion device includes at least one coil stator and rotor pair disposed at either a junction of the head and base, or within the base proximal to a lower-most section of the conical structure, or both. The coil and/or rotor may be formed of one or more PCB boards consisting of multiple layers in series and parallel.

The rotor may be secured to the rotating head and include a pair of spaced apart discs, each disc having a plurality of permanent magnets disposed around a periphery thereof with the magnetic axis of each magnet being generally normal to the surface of the disc, the orientation of the magnetic axis of adjacent magnets on each disc alternates, and the orientation of magnets opposing each other on the spaced apart discs is oppositely arranged. The permanent magnets may be mounted on an annular magnetic yoke.

Preferably, the stator coil is formed of at least one annular board having a plurality of generally spiral shaped windings disposed around a periphery thereof, each winding being connected in series.

According to another aspect of the invention, there is provided a system for generating electricity, including an apparatus of the above described type mounted on the roof of a building and in fluid communication with a space under the roof, a battery, and an electrical circuit connecting the apparatus and the battery, whereby use of the apparatus generates electricity for charging the battery.

According to another aspect of the invention, there is provided a method of harvesting energy from multiple sources for the generation of electrical energy, including the steps of:
providing an apparatus of the above described type;
installing the apparatus on a roof of a building in communication with a space under the roof;
connecting the apparatus to a battery via an electrical circuit;
generating electricity due to:
   the apparatus rotating in response to air flow incident on it due to wind and/or thermal heat escaping from underneath the roof, and/or
   sun light incident on the apparatus,
and storing the electrical energy generated in the battery.

### BRIEF DESCRIPTION OF THE DRAWINGS

In order that the invention may be more easily understood, an embodiment will now be described, by way of example only, with reference to the accompanying drawings, in which:

FIG. 1 is a top perspective view of a venting apparatus for generating electricity according to a preferred embodiment of the invention;

FIG. 2 is an underneath perspective view of the apparatus;

FIG. 3 is a side sectional view of the apparatus;

FIG. 4 is a side perspective view of a conical receptacle for use in the apparatus;

FIG. 5 is an illustrative side view of the apparatus;

FIGS. 6a and 6b are close sectional views of energy conversion device fitted to the apparatus;

FIGS. 7a and 7b are plan views of a magnetic disc stator for use in the apparatus;

FIG. 8 is a side perspective view of a coil stator and rotor pair;

FIGS. 9a and 9b are respective side views of upper and lower coils, together forming a stator coil;

FIG. 10a is a close side view of electrical windings on the stator coil;

FIG. 10b is a close side view of alternative electrical windings on the stator coil;

FIG. 11 is a sectioned view of the energy conversion device showing magnetic field lines;

FIG. 12 is a rotor for use in an alternative energy conversion device;

FIG. 13 is a coil stator for use in an alternative energy conversion device;

FIG. 14 is a sectional view of the alternative energy conversion device; and

FIG. 15 is an illustrative side view of a system including the apparatus.

### DETAILED DESCRIPTION

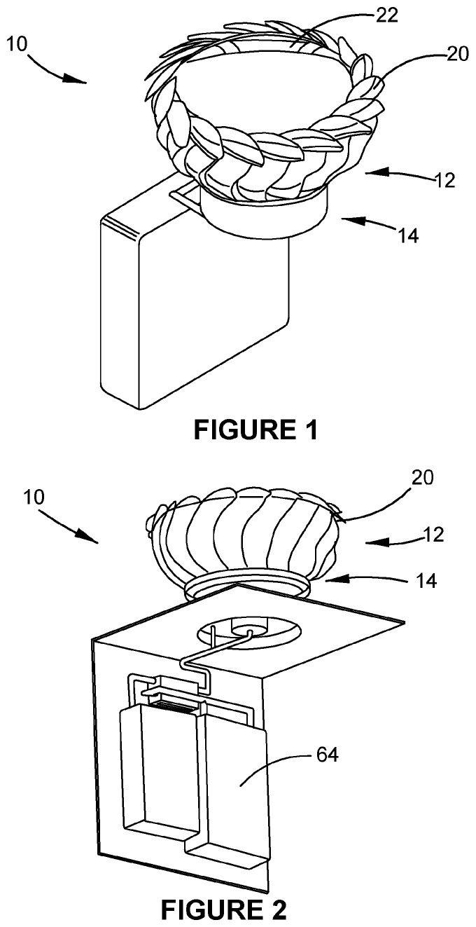

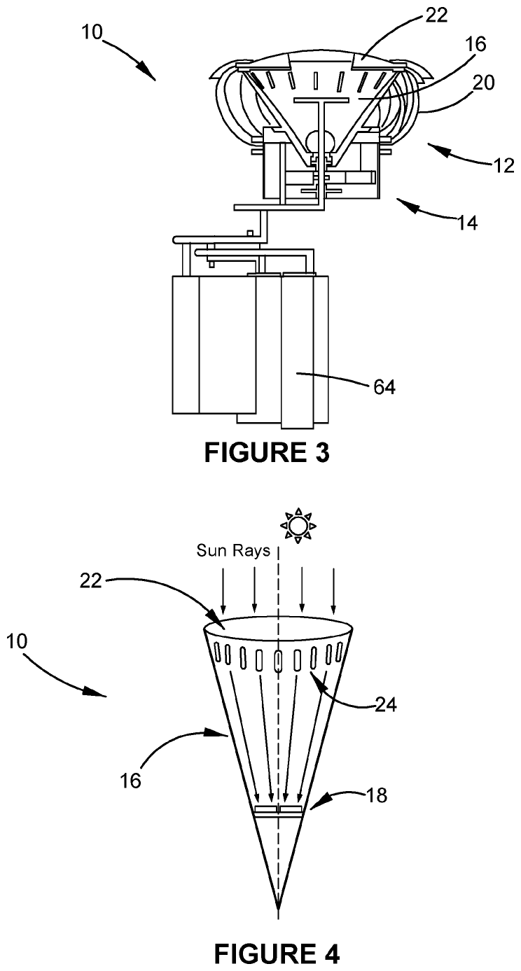

An apparatus 10 is shown in FIG. 1. The Apparatus 10 is for use on a rooftop and configured for generating electricity.

The apparatus 10 comprises a head 12 and a base 14, whereby rotation of the head 12 relative to the base 14 generates electricity. Those skilled in the art will appreciate that the apparatus 10 is similar in form to a conventional turbine vent or ‘whirlybird’ that is commonly installed on a rooftop. Those skilled in the art will also appreciate that the apparatus 10 is not limited to rooftop use and may be used in other situations where venting is being performed, such as from a side of a building or from a basement or underground facility, or from a natural source of geothermal hot air.

The head 12 includes a receptacle 16 in which is disposed a solar cell 18 (FIG. 4). By providing a solar cell 18 in the apparatus 10, the amount of energy generated can be increased as the apparatus operates not only under wind and thermal heat energy but also solar energy. The receptacle 16 is a generally conical structure, though it will be appreciated that it may take other shapes with an open top that are suitable for holding a solar cell.

The solar cell 18 is a photovoltaic (PV) cell configured to convert light energy into electricity. In a preferred form, the solar cell is a concentrator photovoltaic (CPV) cell, which have been found to be more efficient than regular PV cells. The CPV cell also operates at a higher temperature and in addition to generating electricity, generates heat within the receptacle 16, as will be discussed further below.

The head 12 also includes a plurality of blades 20 disposed around a periphery of the head 12 for rotating the head in response to airflow around and/or over the head 12. The air flow may arise from thermal heat generated under the roof and escaping through the apparatus 10 thereby causing rotation of the apparatus, or the air flow may arise from wind passing over the apparatus. The blades 20 are disposed around a periphery of the conical structure 16. The blades 20 take the general shape of a sunflower, though may be otherwise configured, and are configured to rotate under wind of varying speeds and directions. In preferred embodiments, 18 blades are provided. The materials of each blade can be constructed from lightweight metal alloys or carbon fibre materials, recycled durable plastics or other similar materials.

To focus sunlight on the solar cell 18, a convex lens 22 is disposed in an upper of the receptacle 16. The lens 22 is a fixed plano-convex lens positioned at the uppermost point of the receptacle 16 with direct and maximum exposure to sunlight and may extend like a bubble out of the top of the receptacle 16. The lens 22 may also be multipart and comprise both a Fresnal and convex lens. The lens 22 is configured to focus light on a focal point at the lowermost point of the receptacle 16 and acts to maximise the amount of solar energy that can be collected. In preferred embodiments, the lens is a N-BK7 plano-convex lens with an antireflection coating and a 40-20 scratch-dig surface quality, though an ‘economy’ lens with 60-40 scratch-dig surface quality may also be used.

The position of the CPV cell 18 within the receptacle 16 is such that the CPV cell 18 intersects at a designated point above the focal point of the convex lens 22 to absorb maximum solar coverage across the CPV cell 18.

A Fresnal lens may be positioned underneath the lens 20 to potentially increase the length of exposure from radiant sunlight across the day by way of further directing and concentrating rays of sunlight within the receptacle.

As can be seen in FIG. 4, the receptacle 16 has a plurality of circumferentially spaced openings 24 formed in an upper portion thereof and through which thermal heat can escape. As heat is generated by the solar cell 18, warm air within the receptacle builds pressure that needs to escape. The openings 24 are positioned so that air exiting the openings 24 is directed to the blades 20 to further cause rotation of the head 12.

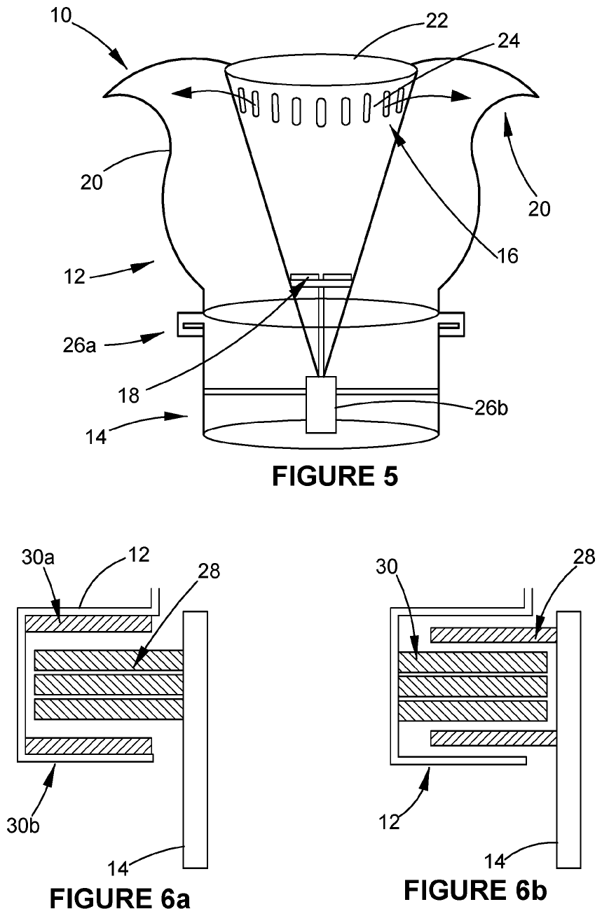

As can be seen in FIG. 5, the apparatus 10 also includes two similar energy conversion devices 26a, 26b for converting rotational energy of the head into electrical energy, a first being disposed at a location where the head 12 meets the base 14, i.e. at a location approximately in a bottom third of the height of the device, and a second being disposed at a lowermost point of the receptacle 16. Although two energy conversion devices are shown, it will be appreciated that in other embodiments, only either one may be present. It will also be appreciated that more than two devices 26 may be provided.

FIGS. 6a and 6b illustrate a close up of the uppermost energy conversion device 26a which is mounted at a location between the head 12 and base 14 and includes a rotor and stator pair that rotate relative to each other. The rotor/stator pair includes a multilayer coil which rotates within a magnetic field to generate electricity.

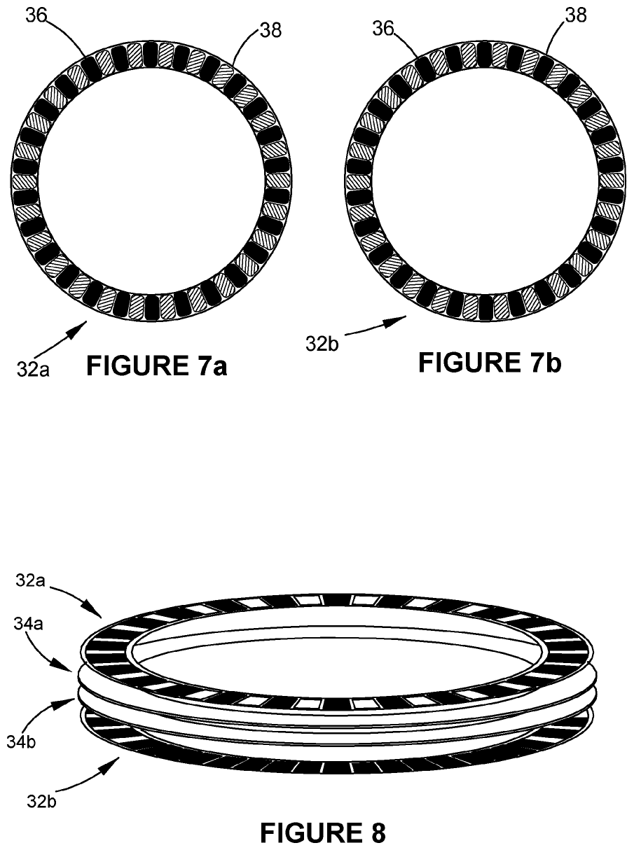

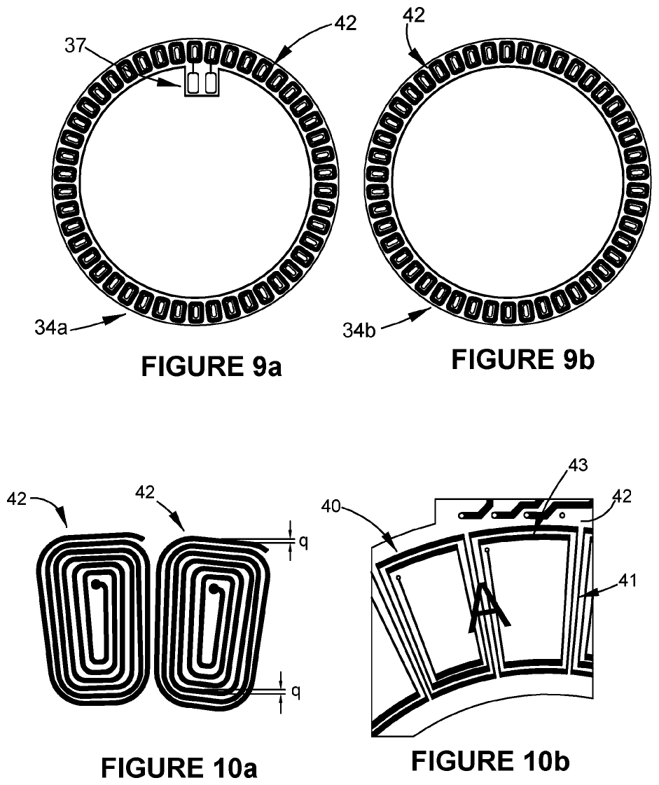

In FIG. 6a, the stator 28 is formed of a multi-layer coil 34a, 34b (FIG. 9) whereas the rotor 30 is formed a pair of discs 32a, 32b (FIG. 7) with permanent magnets disposed thereon and between which a static magnetic field is formed.

FIG. 6b illustrates an opposite configuration wherein the stator 28 is formed by the pair of discs 32a, 32b (FIG. 7) with permanent magnets disposed thereon and the rotor 30 is formed by the multi-layer coils 34a, 34b (FIG. 9).

Although alternative constructions are possible, it is preferred that magnetic discs 32a, 32b are used as the stator to reduce rotating weight.

To create the magnetic field within the space between the discs 32a, 32b, the outer and inner discs 32a, 32b have, on opposing surfaces thereof, a plurality of permanent magnets 36 disposed thereon or embedded within. The magnets 36 are disposed around a periphery of each disc and mounted on an annular magnetic yoke 38. The magnets 36 are arranged so that the magnetic axis of each magnet 36 is generally normal to the surface of the disc.

Permanent magnets 36 are preferably formed from a material with a higher residual induction such as NdFeB N52 (Neodymium iron boron), which has a residual induction of 1.43 T and relative permeability of 1.05.

Yokes 38 are provided to reduce the magnetic resistance torque and magnetic flux leakage as well as to improve the magnetic flux density in the air gap. Yokes 38 are preferably made of soft magnetic materials. To achieve a high saturation flux density to decrease yoke volume and a high magnetic permeability to decrease leakage flux, permalloy 1J85, permalloy 1J50, electromagnetic pure iron and ferrocobalt 1J22 may be examples of suitable materials.

The orientation of the magnets 36 is such that adjacent magnets are alternatingly arranged, i.e., the magnetic axis of adjacent magnets on each disc alternates. With reference to FIGS. 7a and 7b, it can be seen that a magnet with a visible north pole is placed next to a magnet with its opposite pole, i.e., the south pole, visible.

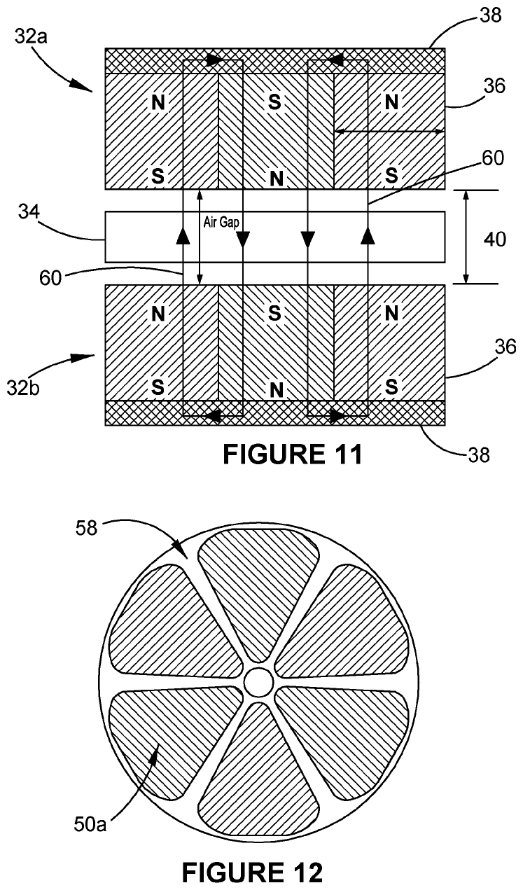

The discs 32a, 32b are also arranged so that when coupled together, the orientation of magnets opposing each other on the spaced apart discs 32a, 32b is oppositely arranged. This can be seen in FIG. 11 which illustrates the arrangement of FIGS. 6a and 6b, whereby on an upper disc 32a, a permanent magnet 36 with an outward north pole is opposite a permanent magnet 36 with an outward south pole. This results in the magnetic flux line 60 shown in FIG. 11, whereby the magnetic field passes through air gap 40 such that relative movement of the discs 32a, 32b and the coil 34 causes the coil 34 to pass through the magnetic field 60 and create an electrical current being generated in the coil 34. Owing to such an arrangement, rotation of the head 12 relative to the base 14 will result in the generation of electrical power.

The inventors believe that by configuring the outer and inner discs 32a, 32b with permanent magnets as disclosed herein, it will be possible to establish a static magnetic field between discs 32a, 32b, as illustrated in FIG. 11, i.e., one which passes directly across the air gap 40. This static magnetic field is expected to reduce magnetic resistive torque so that electricity can be generated during rotation of the head 12 relative to the base 14 with minimal magnetic resistance. Owing to the described arrangement, the static magnetic field is also expected to reduce hysteresis loss and eddy-current loss, thereby greatly improving generating performance significantly.

FIGS. 9a, 9b illustrate the multi-layer coils 34a, 34b. The coils form the stator 28 in FIG. 6a and the rotor 30 in FIG. 6b.

Each annular board 34a, 34b has a plurality of generally spiral shaped windings 42 (FIG. 10) disposed around a periphery of it. The two boards 34a, 34b of one pair are connected together in series and in the pair, each coil 42 is connected via a connector extending through a hole at the centre of the coil above and below it. An internal connector point 37 is fixed to the base of board 34a.

Each annular board 34a, 34b is fabricated by printed circuit board (PCB) technology and made of non-magnetic materials with copper for the wires. The base is preferably glass-bonded mica with a relatively high permittivity (dielectric constant) of 6.3 to 9.3. The importance of this material is to absorb the resultant magnetic field created when a current is produced within the coil structure whilst moving through a magnetic field. This material will provide the capacitance required to reduce the magnetic torque otherwise created within a standard coil winding as determined in accordance with Lenz's Law. Compared with the coils fabricated by traditional filament winding methods, the PCB based multilayer coil integrates coils and substrates within an integrated thin structure, leading to a smaller air-gap thickness and higher air-gap magnetic flux density, hence better output performance.

The number, configuration and overall design of the coil structure will be important to maximise the effect of magnetic flux and output voltage in relation to rotational speed. Although shown as having a single pair of boards 34a, 34b, it will be appreciated that multiple board pairs may be provided. To minimise space, multiple boards may be provided as a multilayer PCB, the boards being connected in either series or parallel depending on the output required.

As can be seen in FIG. 10b, in one embodiment the coils 40 are formed with thicker and thinner portions and arranged so that the magnetic flux generated by the magnets is incident only on the thinner portions. In this regard, the thinned portions 41 of the coil extend generally radially on the board 42 whereas the thicker portions 43 extend in a direction generally circumferential though inset for a periphery of the board 42.

With reference to FIG. 12, a further energy conversion device 26b may also be provided at the base of the receptacle 16. Energy conversion device 26b is similarly constructed to device 26a and includes a pair of magnetic discs 50a, 50b, between which a multi layer coil 52 rotates.

Device 26b is mounted on a spindle 54 coupled to the base of the receptacle 16 and rotatably supported via bearings 56. Although device 26b is illustrated as having coils 52 rotating on spindle 54, in alternative embodiments magnetic discs 50a, 50b may rotate on spindle 54.

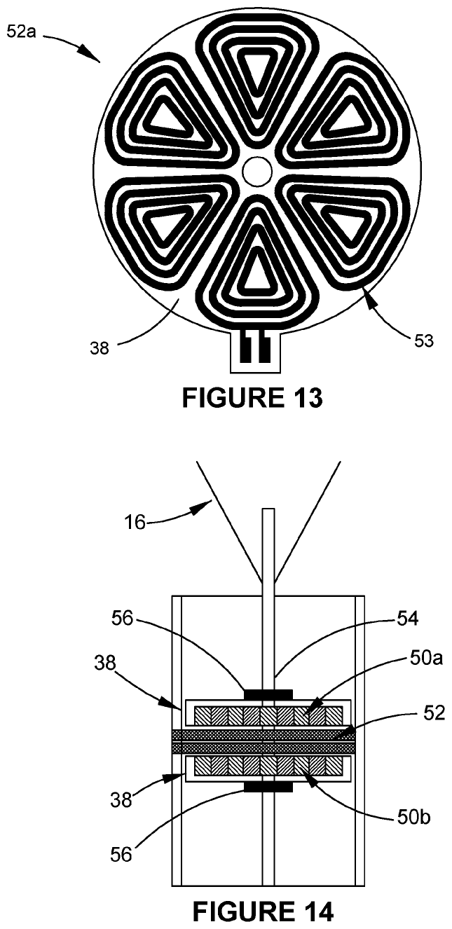

As illustrated in FIG. 12, each magnetic disc 50a includes a plurality of permanent magnets 36 arranged on a magnetic yoke 38 so that adjacent magnets have alternating magnetic axes. Similarly, FIG. 13 illustrates a coil 52a with a plurality of spiral shaped windings 53 disposed around it.

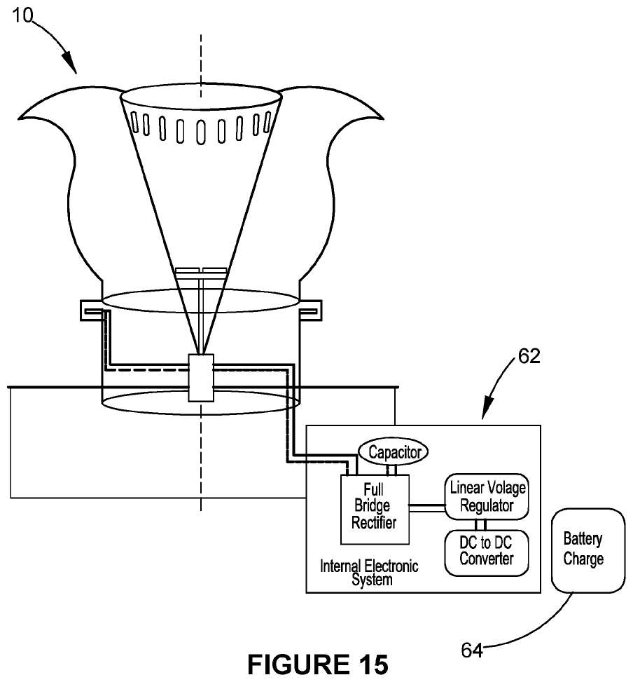

FIG. 15 illustrates a system for generating electricity including apparatus 10, a battery 64, and an internal electronic system 62 for connecting the apparatus and the battery 64. In use, operation of the apparatus 10 generates electricity from wind, solar and thermal energy for charging the battery 64. The battery 64 may be connected to the power circuit of a house or other structure to generate power independently of the grid.

Many modifications of the above embodiments will be apparent to those skilled in the art without departing from the scope of the present invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A venting apparatus for generating electricity, the apparatus comprising a head and a base, whereby rotation of the head relative to the base generates electricity, wherein the head includes:
a receptacle in which is disposed a solar cell, and
a plurality of blades disposed around a periphery of the head for rotating the head in response to airflow around and/or over the head.

2. An apparatus according to claim 1, wherein the receptacle is a generally conical structure.

3. An apparatus according to claim 2, wherein the blades are disposed around a periphery of the conical structure.

4. An apparatus according to any preceding claim, further comprising a convex lens, a Fresnal lens or combinations thereof, disposed in an upper of the receptacle for focusing sunlight onto the solar cell.

5. An apparatus according to any preceding claim, wherein the solar cell is configured to output electricity with heat being generated as a by-product.

6. An apparatus according to any preceding claim, wherein the receptacle has a plurality of circumferentially spaced openings formed in an upper portion thereof and through which thermal heat can escape.

7. An apparatus according to claim 6, wherein the openings are positioned so that air exiting the openings is directed to the blades to cause rotation of the head.

8. An apparatus according to any preceding claim, further comprising at least one energy conversion device for converting rotational energy of the head into electrical energy.

9. An apparatus according to claim 8, wherein the energy conversion device includes at least one coil stator and rotor pair disposed at either a junction of the head and base, or within the base proximal to a lower-most section of the conical structure, or both.

10. An apparatus according to claim 9, wherein the rotor is secured to the rotating head and includes a pair of spaced apart discs, each disc having a plurality of permanent magnets disposed around a periphery thereof with the magnetic axis of each magnet being generally normal to the surface of the disc, the orientation of the magnetic axis of adjacent magnets on each disc alternates, and the orientation of magnets opposing each other on the spaced apart discs is oppositely arranged.

11. An apparatus according to claim 10, wherein the permanent magnets are mounted on an annular magnetic yoke.

12. An apparatus according to any one of claims 9 to 11, wherein the stator coil is formed of at least one annular board having a plurality of generally spiral shaped windings disposed around a periphery thereof, each winding being connected in series.

13. A system for generating electricity, including an apparatus according to any preceding claim mounted on the roof of a building and in fluid communication with a space under the roof, a battery, and an electrical circuit connecting the apparatus and the battery, whereby use of the apparatus generates electricity for charging the battery.

14. A method of harvesting energy from multiple sources for the generation of electrical energy, including the steps of:
providing an apparatus according to any one of claims 1 to 12;
installing the apparatus on a roof of a building in communication with a space under the roof;
connecting the apparatus to a battery via an electrical circuit;
generating electricity due to:
the apparatus rotating in response to air flow incident on it due to wind and/or thermal heat escaping from underneath the roof, and/or
sun light incident on the apparatus,
and storing the electrical energy generated in the battery.
